(19) United States
(12) Patent Application Publication
(10) Pub. No.: US 2008/0287845 A1
(43) Pub. Date: Nov. 20, 2008

(54) Electric shower masseuse

(75) Inventor: Hani Elias Chika, San Diego, CA (US)

Correspondence Address: Hani Elias Chika, 4690 Crawford Court, San Diego, CA, 92120, US

(73) Assignee: Hani Elias Chika, San Diego, CA (US)

(21) Appl. No.: 12/081,965

(22) Filed: Apr. 24, 2008

Related U.S. Application Data
(60) Provisional application No. 60/924,485, filed on May 17, 2007.

(51) Int. Cl. A61H 33/00

(52) U.S. Cl. 601/158

(57) ABSTRACT

The present invention is suspended between the shower sliding door frame and the opposite shower wall. It has two large rotating disk wheels that massage and clean the body. A water reservoir allows soapy water to flow gently onto both shower disk wheels continuously, enabling the user to limit the volume of water used. The disk wheels spin in opposite directions at the same speed, controlled by a single motor and a drive belt that rotates two shafts. The lower disk wheel moves forward and backward to conform to the contours of the body. The unit is braced against the back wall of the shower enclosure and kept in position by adjustable arms. It can be raised and lowered to clean the upper and lower body. Its speed and efficiency lead to conserving water, time, and energy. The invention is especially useful for anyone with limited hand or arm mobility.

### SPECIFICATION

The Electric Shower Masseuse is related to Classification 4 (Baths, Closets, Sinks, and Spittoons). This refers to subject matter having means for spraying water on the body of a user, and sub-class 605 (Convenience Accessories), which is subject matter wherein there is provided additional means for aiding or adding to the comfort of the user, or to perfect the shower.

It is also related to Classification 601 (Surgery: Kinesitherapy). This refers to subject matter designed to act upon the body by moving, vibrating, or massaging a portion of the body to produce a therapeutic effect and in which the movement of the patient is passive, and sub-class 136 (Frictioning), wherein the body-contacting means rubs the body or acts upon the body by surface resistance to relative motion.

The present invention is directed to a unit that is suspended in the shower enclosure. This device cleans and massages the body while saving time, energy, and water. The device enables the user to clean not just the hard-to-reach areas, but the entire body, effectively and efficiently.

The horizontal bar that hangs the Electric Shower Masseuse can be adjusted to fit any width shower enclosure. A rail is mounted on the inside wall of the shower. One end of the horizontal bar slides inside the rail to position the unit at the appropriate place within the length of the shower. The other end of the horizontal bar fits over the shower door enclosure and is tightened in place. A spring pushes the horizontal bar toward the wall so that the unit is firmly positioned in place.

The Electric Shower Masseuse is braced against the back wall of the shower by two support arms that adjust to any distance necessary.

Facing the disk wheels, the upper disk wheel rotates counter-clockwise and the lower disk wheel rotates clockwise (although they can be reversed). Two disk wheels spinning in opposite directions at the same speed stabilize and balance the unit so that it stays in the center location. By changing the motor, the disk wheels can be set up to rotate faster or slower. The disk wheels can also be set to vibrate or make half-turns back and forth. It is also possible to configure the unit for ultrasonic cleaning. While it is spinning, the lower disk wheel can be pushed backward and forward to fit the contours of the body. The fronts of the disk wheels are made of soft fabric impression rubber. Beneath the rubber is flexible padding to give the disk wheels a convex shape. The disk wheels can be covered with removable fabric. When the unit is on, a soapy water reservoir dispenses soapy water to coat the rubber disk wheels.

To operate the device, the user positions the Electric Shower Masseuse by pulling the pulley rope vertically as needed so that the upper disk is at shoulder level. The user fills the water reservoir with water and liquid soap. The user then lowers the water dispensing tube to the horizontal position so that the rubber end of the tube can reach the body. This will allow the soapy water to flow onto the shower disk wheels and onto the body. Because clean water is continuously flowing, the user can limit the volume of water coming from the showerhead until it is time to rinse.

The user turns on the Electric Shower Masseuse and leans toward the disk wheels. To begin, the user leans one arm into the disk wheel, and then rotates the arm to clean both the outside and the inside of the arm. The user then turns slowly, keeping the front of the body in constant touch with both disk wheels, allowing them to clean and massage the body. When the other arm is in contact with the shower disk wheel, the user follows the same process as the first. As the Electric Shower Masseuse massages the back, hands will be free for additional cleaning. The lower disk wheel can be pushed in and out, enabling it to stay in contact with the contours of the body.

After two full turns, the user can release the pulley rope and lower the unit so that the lower disk wheel is at knee level. The user washes the lower half of the body with another one or two full turns, and the body is fully clean.

The Electric Shower Masseuse is operated by rechargeable batteries or by electricity using an AC transformer mounted outside the shower enclosure.

### CROSS-REFERENCE TO RELATED APPLICATIONS

Not applicable.

### BACKGROUND OF THE INVENTION

In October 2004, I was taking a shower as usual but I had a pain in my right elbow. Taking a shower was very difficult. I started looking for some electrical means on the market to help me shower thoroughly and comfortably; I could not find anything that worked. As an inventor, I knew I could do something about it. There are many electric tools such as the electric toothbrush, car wash, electrical massager, etc. Why not an electric shower masseuse? It cleans, massages, and scrubs the body gently just by the click of a switch. I made sketches and a prototype, and gave them to a machinist to refine the components. I continued to improve the design, testing it and looking for the right materials. I made more sketches and drawings and gave them to the machinist. Then I tested the product and made changes on the drawings as needed. Finally, I was satisfied with the product.

The present invention is related to Classification 4 (Baths, Closets, Sinks, and Spittoons). This refers to subject matter having means for spraying water on the body of a user, and sub-class 605 (Convenience Accessories), which is subject matter wherein there is provided additional means for aiding or adding to the comfort of the user, or to perfect the shower.

It is also related to Classification 601 (Surgery: Kinesitherapy). This refers to subject matter designed to act upon the body by moving, vibrating, or massaging a portion of the body to produce a therapeutic effect and in which the movement of the patient is passive, and sub-class 136 (Frictioning), wherein the body-contacting means rubs the body or acts upon the body by surface resistance to relative motion.

The present invention is directed to a unit that is suspended in the shower enclosure. This device cleans and massages the body while saving time, energy, and water. The device enables the user to clean not just the hard-to-reach areas, but the entire body, effectively and efficiently.

The device also has applications for people with limited arm or hand mobility. Although there are devices like electric toothbrushes and electric massagers, there is still a need for an electrical means to help shower thoroughly and comfortably, as well as for a device that enables the users to save time, energy, and water.

Known prior art includes U.S. Pat. No. 6,732,394; U.S. Pat. No. 5,239,712; and US Patent Application Publication Number US 2003/0167565 A1.

This device differs from prior art in several key dimensions:

1. It is suspended freely from the frame of the shower, as opposed to being handheld or attached to the wall or shower head. The suspension system is designed to position the unit at the desired location in the shower quickly and easily and the unit is held there securely. This is accomplished by installing a rail on the wall of the shower opposite the door frame. One end of the hanging bar slides inside the wall rail. The other end of the hanging bar fits over the shower door frame and is held there with a system of door support blocks that are tightened by knobs and screws. A powerful hidden spring pushes the first end of the hanging bar toward the wall to ensure its stability.

2. The disk wheels are designed to rotate in opposite directions at exactly the same speed. This is accomplished by using one motor to propel two pulleys that are connected by means of a round belt. The belt is configured in the shape of a figure eight, thereby rotating the two shafts in opposite directions. Because the two disk wheel spin at exactly the same speed in opposite directions (clockwise and counter-clockwise), the unit is stabilized while the disk wheels are in motion. The disk wheels can be configured to move faster or slower by changing the motor. The size and speed of the disk wheels are important in order to maximize time efficiency and thereby maximize water conservation. A typical shower can be shortened about two minutes, still allowing the user to be fully clean.

3. The lower disk wheel can be moved backward and forward while it is spinning to conform to the contours of the body. This is accomplished with a system of sliding tubes; two rods move freely inside four tubes. As the user leans on the lower disk wheel, the tubes slide inside each other and the disk wheel moves backward. When the user releases the pressure, springs return the disk wheel to the original position automatically. This allows the cleaning and massaging disk wheel to conform to the contours of the user's body. The belt and pulley system is the key to making this process work. The first important point is that the stretchable belt is round, rather than flat. This is necessary so that as the lower pulley is moved backward and forward by the pressure on the disk wheel, the belt can roll around itself and not be forced off the pulley. The pulleys have a special design that includes a deeper-than-typical side wall and a flat (not rounded) belt surface that is imbedded with inverted V-shaped notches that grip the belt and keep it from slipping.

4. Because the belt is in the shape of a figure eight, the two parts of the belt need to be separated where they cross each other. A separator guide was invented, consisting of a metal nail, surrounded by a metal tube. A metal pin runs through a hole in the sharp end of the nail and attaches it to the center of a hollow rubber pad that is secured to the body of the unit. This design allows the nail inside the tube to move almost 70 degrees in any direction as the belt turns.

5. The unit can be raised and lowered in a single motion to clean both the upper and lower body. While the preferred embodiment shows a system of pulleys and ropes, the unit can also be motorized to perform this function.

6. The arms that support the back of the unit and hold it firmly away from the wall also have unique design features. A single control knob allows the user to control the distance from the wall. Loosening the knob allows a spring to pull the arms together. Pushing the body against the disk wheels forces the arms apart; at the desired distance, the control knob is tightened to hold the arms in the desired position. The user is able to set a variety of distances because of the design of the T-shaped back support rail. The rail includes an open channel the length of the rail through which the control knob and its screw pass. The screw can be fastened at any point on the channel because of the design of the securing mechanism. This mechanism consists of a square ring with a flat square inside at the bottom. The square ring is placed around the long portion of the T-shaped rail. The screw of the knob passes through the top of the square ring, through the open channel, and through the flat square, then through the bottom of the square ring. When the control knob is tightened, the flat square is drawn up toward the plastic channel of the T-shaped rail. Small teeth on the flat square grip the plastic tightly and hold the square ring at the desired position.

### BRIEF SUMMARY OF THE INVENTION

The intention of the present invention is to demonstrate the following benefits:

1. Clean the body very quickly and much more thoroughly, especially hard-to-reach areas on the back, sides or lower body.

2. Massage the body and rejuvenate the skin, while being very gentle to all sensitive parts of the body.

3. Save time and money.

4. Conserve energy by using less hot water.

5. Conserve water in the shower (as much as 70%, as documented by the inventor's personal water bills), especially important in areas with water shortages.

6. Preserve the environment by conserving on hot water and natural gas.

7. Enjoy the pleasant feeling of a gentle and warm body massage, without relying on water pressure.

8. Clean the body thoroughly even for people with limited mobility.

9. Self-cleaning; since the device does not depend on a brush, the surface that touches the body is continually bathed in clean soapy water, and residue cannot accumulate.

10. Rechargeable batteries, good for about 60 minutes or more of use between charges, depending on the motor requirement and the number of batteries used.

This device solves many of the problems of previous inventions, as follows:

Because other inventions (such as U.S. Pat. No. 5,239,712 and U.S. Pat. No. 6,775,864) rely on water flow from the shower to provide the massage function, they cannot also conserve water.

Because other inventions (such as U.S. Pat. No. 7,308,724 and U.S. Pat. No. 5,033,897) do not have a means to be mounted in the shower enclosure, using them requires that the user hold them in the hand.

Because other inventions (such as U.S. Patent Application Publication # 2003/0167565, U.S. Pat. No. 6,732,394, U.S. Pat. No. 4,274,400 and U.S. Pat. No. 7,120,947) that are mounted in the shower are completely fixed, the portions that touch the body cannot be moved forward and backward at will. The present invention allows adjustment to conform to the contours of the user's body.

### BRIEF DESCRIPTION OF THE SEVERAL VIEWS OF THE DRAWING

The drawings of one of the preferred embodiments of the invention are included, as follows:

Sheet 1/5, FIG. #1, view of the front side

Sheet 2/5, FIG. #2A, detail view of the interior, upper shaft assembly

Sheet 3/5, FIG. #2B, detail view of the interior, lower shaft assembly

Sheet 4/5, FIG. #3A, detail view of the lower portion of the back side

Sheet 5/5, FIG. #3B, detail view of the upper portion of the back side

### DETAILED DESCRIPTION OF THE INVENTION

The Electric Shower Masseuse is generally shown as 57 (FIG. #1). The device consists of upper interior components (FIG. #2A), lower interior components (FIG. #2B), and a back-to-wall support (FIG. #3A), all attached to a body 18 and hung from a T-shaped suspension system (FIG. #3B).

### Upper Interior Components (FIG. #2A)

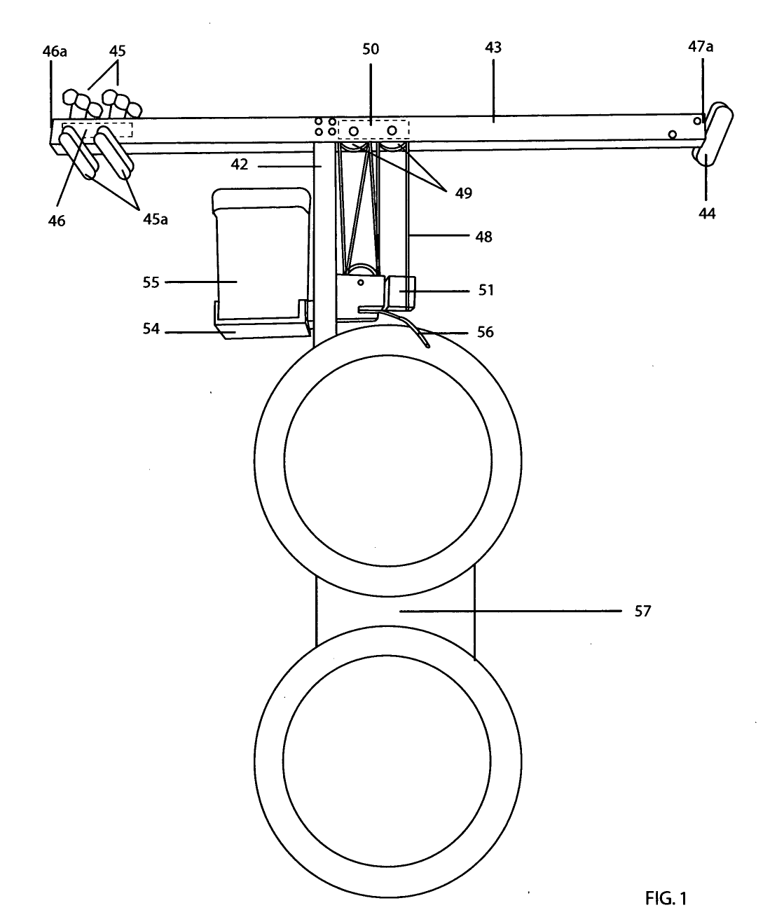

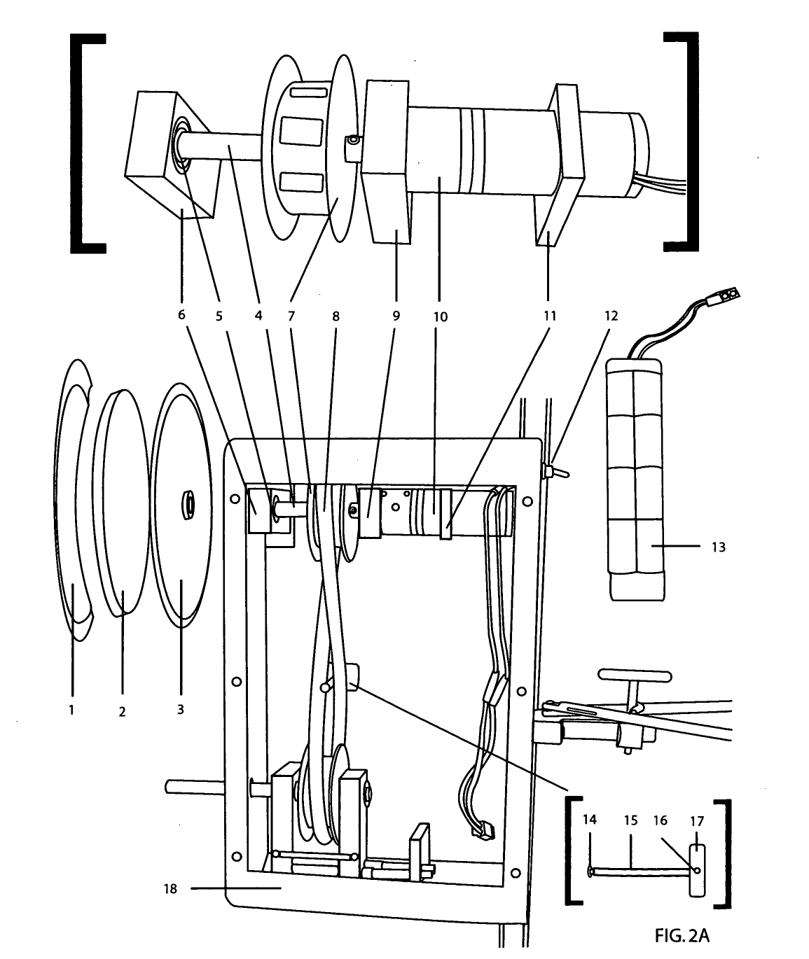

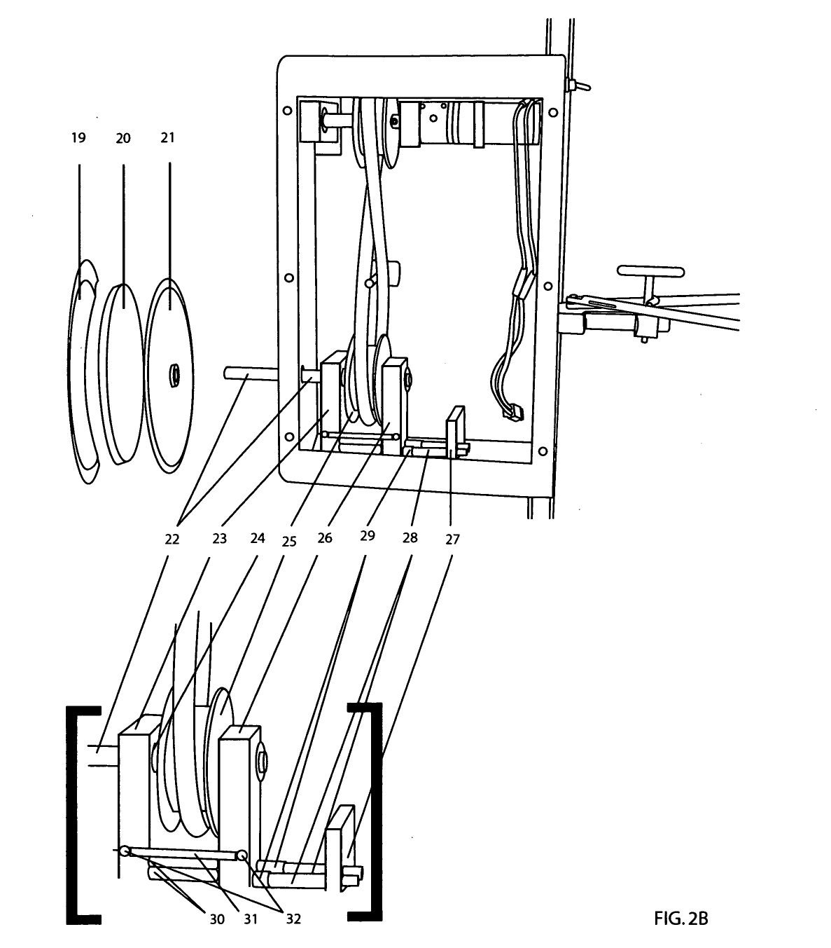

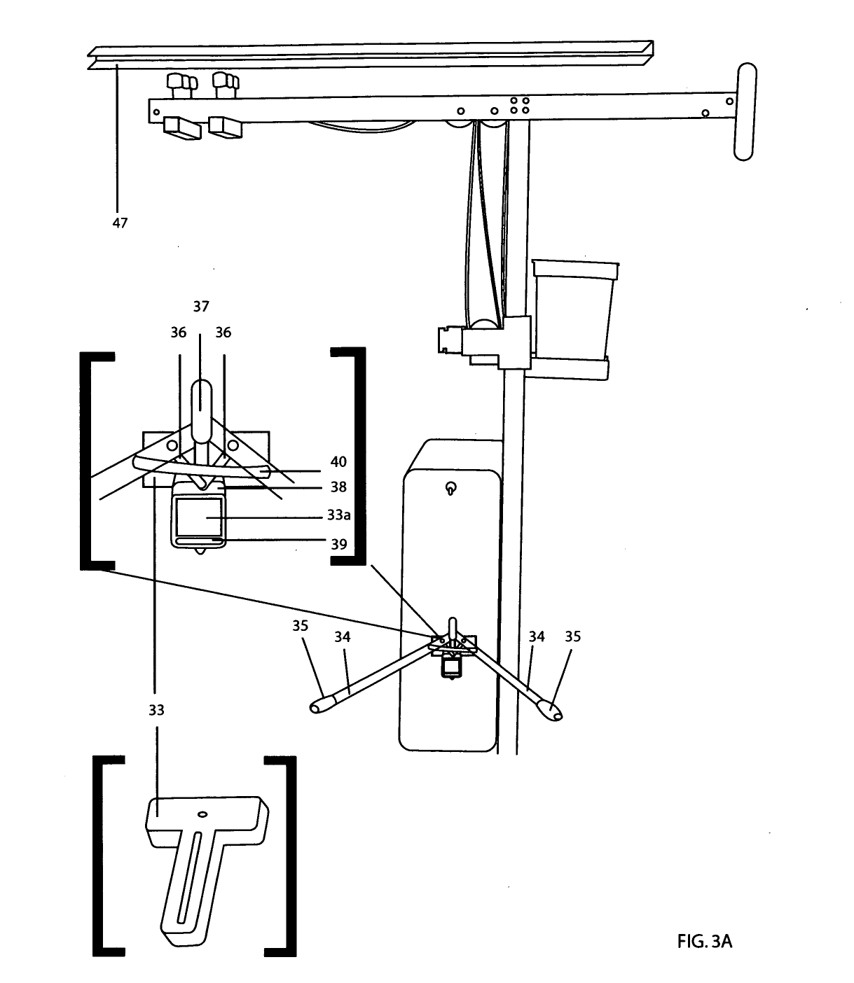

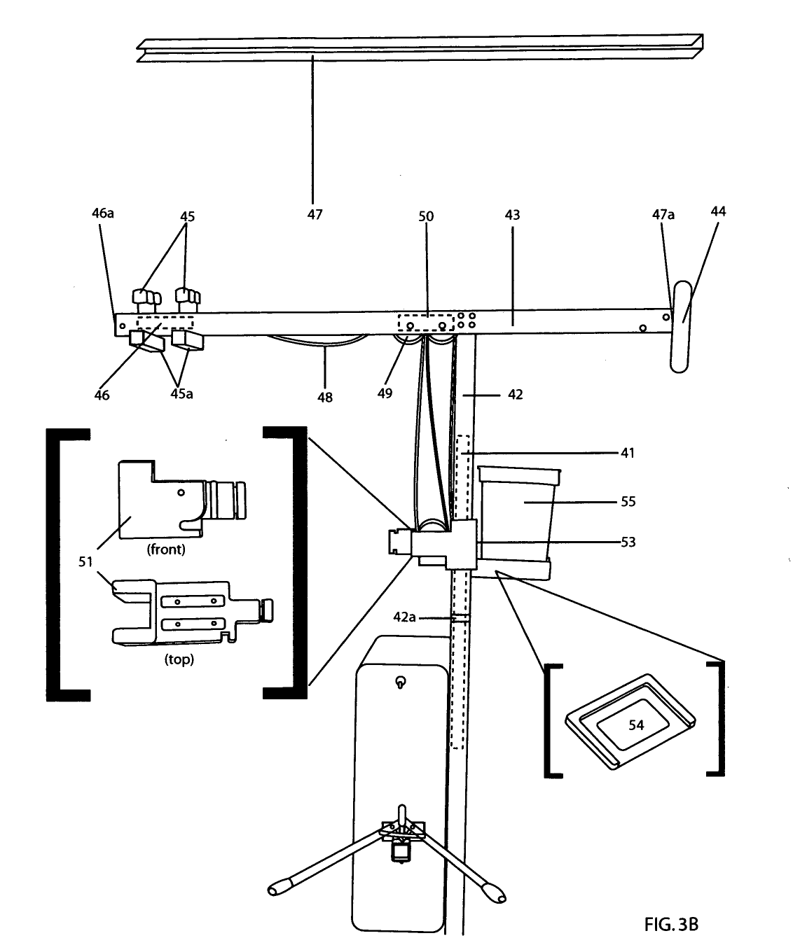

The upper interior components are operated by a switch 12 and a motor 10, which can be powered by batteries 13 or an AC/DC transformer connected to ordinary household current. The motor 10 and the motor shaft 4 are supported by mounting blocks 11, 9, and 6. The motor shaft 4 also drives a disk wheel assembly, consisting of a rigid back support 3, flexible padding 2 that creates a convex shape, and a waterproof cover 1. The disk wheel assembly is sealed so that water and bacteria cannot affect the padding. A pulley 7, with circular bearings 5 on each side, is also connected to the motor shaft 4, and propels a belt 8, which connects to the lower interior components. The pulley 7 has unique design features that support its function in ensuring that the belt stays within the track of the pulley even as it moves forward and backward with the lower motor shaft 22. The belt 8 is assembled in a FIG. 8 position to enable it to rotate the upper and lower disk wheel assemblies in opposite directions.

A separator (14, 15, 16,17) is mounted between the upper and lower interior components at the point where the belt 8 crosses itself. The separator (14, 15, 16, 17) can spin freely between the two sections of the belt 8 as it rolls and moves forward and backward, virtually eliminating friction.

### Lower Interior Components (FIG. #2B)

The lower interior components support two purposes: to rotate the lower disk wheel and to enable the lower disk wheel to move forward and backward while it is spinning. The disk wheel assembly, consisting of a rigid back support 21, flexible padding 20, and a waterproof cover 19, is rotated by a motor shaft 22, which is operated by the same motor 10 via the belt 8 and lower pulley 25. The disk wheel assembly is sealed so that water and bacteria cannot affect the padding. Two mounting blocks 23 and 27 attach the lower interior components to the body 18. A third mounting block 26 is secured to one end of the motor shaft 22. Four circular bearings 24 are located on either side of mounting blocks 23 and 26.

The mechanism that allows the lower disk wheel assembly to move forward and backward consists of two sets of rails and tubes (28, 29, and 30) that compress and expand to allow the movement when the user applies pressure to the disk wheel. Springs 31, secured by screws 32, push the lower disk wheel assembly back to its original position after the pressure from the user has been released.

### Back-to-Wall-Support (FIG. #3A)

A T-shaped rail 33 attaches to the body 18. It includes a hole to secure the arms 34 as well as an open channel that is used to set the unit at the desired distance from the wall. The end of the T-shaped rail 33a is rubber to cushion the back-to-wall support against the shower wall.

Each of the two arms 34 has a hole drilled at one end as well as slots drilled through the Arm near that end. The ends 35 are covered with rubber to protect the shower wall. Braces 36 attach to the arms 34 and the T-shaped rail 33 and are used to open and close the arms 34, thereby regulating the distance from the shower wall. A knob 37 controls the action of the braces 36. The screw portion of the knob 37 passes through the open channel of the T-shaped rail 33 and is secured in any desired position by a square ring 38 and a flat square 39. A spring 40 allows the arms 34 to close when the knob 37 is released.

### T-Shaped Hanging System (FIG. #3B)

The T-shaped hanging system consists of a horizontal and a vertical component. The horizontal component is based on a hanging bar 43. It contains the upper part of the pulley mechanism 50 for raising and lowering the unit. At one end, a holding bar 44 connects to a block 47a and slides into a wall-mounted rail 47 to stabilize the bar 43; at the other end, two holding knobs 45 secure the bar to the shower door frame.

The inner knob 45 is also connected to one end of a powerful spring 46. The other end of the spring connects to a block 46a at the outer end of the bar 43 and pulls the end of the bar 43 toward the wall-mounted rail 47. The outer knob 45 is stationary to hold the horizontal bar 43 in place. Once the bar 43 is in place, the knobs 45 are tightened to keep it from moving sideways, while still allowing it to move freely back and forth along the top of the sliding door frame. At the base of the knobs 45, blocks 45a secure the bar 43 to the shower door frame.

The vertical component of the hanging system includes an inner slider 41 that attaches to the body 18. Surrounding the inner slider 41 is an outer slider 42, which is connected to the horizontal bar 43. A small collar 42a ensures that the inner slider 41 and the outer slider 42 remain connected.

Pulley cords 48 are used to raise and lower the unit so that it reaches the entire body. Multiple pulleys 49 are used to distribute the weight. The upper pulleys 49 are connected to the horizontal bar 43, and the lower pulleys 49 fit into a holder 51, which is mounted on the outer slider 42 with a flat panel 53.

The holder 51 serves several purposes. In addition to supporting the lower pulleys 49, it also provides a notch at the end to secure the pulley cords 48. The holder 51 also connects to the water reservoir base 54 and the water reservoir 55. It provides support for the water delivery tube 56, which is secured upright when it is not being used, and rotates to a horizontal position to dispense soapy water. The end of the tube is rubber, which moves freely when in contact with the body to touch the skin gently. As an alternative to the gravity-activated method of dispensing the water, the water reservoir can be operated automatically with a motor and switch.

Prior art lacks many of these features, for example:

1. A search of patents found no other invention that suspended the device from the shower door frame. The spring mechanism for holding the horizontal bar firmly against the opposite wall is also not in prior art.

2. In addition, although other inventions presented rotating disks, none included a means for setting up one motor to rotate two disk wheels in opposite directions at exactly the same speed.

3. No invention cited includes a mechanism that allows for the lower disk wheel to be moved forward and backward while it is spinning to conform to the contours of the body. This invention uses a system of sliding tubes that compress to move the lower disk wheel forward, and springs to return it to its original position.

4. The design of the belt and pulleys relies on a round belt being configured in a FIG. 8 shape. The fact that the two sections of the belt cross each other required the invention of a separator to remove the friction. No other invention found mentioned a separator guide.

5. Because one of the intentions of this device is conservation of water, time, and energy, it was expressly designed with two disk wheels (to cover more surface area), a high rate of speed, and a mechanism for raising and lowering the unit efficiently so that the entire body can be cleaned and massaged in a very short period of time.

6. The means for bracing the unit against the back of the shower wall is not represented in other inventions searched. The arms are controlled by a single knob; loosening the knob causes the arms to spring together, while pressure against the arms will push them open toward the wall. The knob is threaded through an open channel on a rail at the back of the unit. It is secured along the back support rail because the screw in the knob is connected to a flat square with sharp teeth that tighten against the rail and allow the connection to hold at any point.

I claim:

1. An electric shower masseuse machine that is mounted in the shower enclosure and provides a means to clean and massage the body in a very short time, said machine comprising:
a. A mounting apparatus consisting of a horizontal bar and vertical bars, along with a rope and pulleys to raise and lower the unit;
b. A back support system to position the unit securely against the back wall of the shower enclosure at any desired position;
c. A body that houses the motor and belt-driven pulley system;
d. Two rotating disk wheels that clean and massage the body; and
e. A soapy water delivery system that provides a continuous supply of clean soapy water to coat the disk wheels.

2. A machine according to claim 1 wherein the back-to-wall support system is controlled by a T-shaped control screw, such that:
a. The T-shaped control screw is connected to the ends of two arms that move together and apart through braces and a spring to reposition the arms' distance between the unit and the wall.
b. The T-shaped control screw moves freely within a channel on the back support rail to allow great flexibility in setting the distance.
c. The T-shaped control screw attaches firmly to the back support rail with the following structure:
i. A square metal ring surrounds the back support rail and can be moved to any position along the channel opening.
ii. Inside of the square metal ring is a flat square that has four inverted V-shaped notches that are positioned perpendicular to the length of the back support rail.
iii. As the T-shaped control screw is tightened, the flat square is drawn upwards and the notches embed themselves in the plastic rail material to hold the screw position at the desired location.

3. A machine according to claim 1 wherein one motor is used to power two motor shafts as follows:
a. The motor is connected to a motor shaft, which is connected to one of the rubber disk wheels; a pulley is located between the motor and the disk and is rotated by the same motor shaft.
b. The first pulley is connected to a second pulley at the bottom of the unit by means of a round rubber belt.
c. The second pulley is connected to a second shaft, which rotates the second rubber disk wheel at the exact same speed as the first rubber disk wheel.
d. The rubber belt is configured in the shape of a figure eight, rotating one shaft clockwise and the other shaft counter-clockwise, thereby providing balance and stability to the unit when the disk wheels are spinning.
e. A separator guide is positioned where the rubber belt crosses itself to form a figure eight, between the two parts of the belt to reduce friction on the belt.
f. Because the second pulley can be pushed back and forth at the base of the unit, the rubber belt is round so that it can roll with the movement of the pulley and stay inside the pulley.
g. The sides of the pulley are high enough that the rubber belt cannot move out of the pulley.
h. The center core of the pulley is flat and embedded with inverted V-shaped notches that grip the rubber belt and propel it around.
i. Around the center hole of the pulley are round extensions that come in touch with the moving balls in circular bearings to prevent friction between the surface of the pulley and its support block.

4. A device according to claim 3 that forms a separator guide for the rubber belt, as follows:
a. Metal in the shape of a nail is surrounded by a hollow metal tube.
b. The sharp end of the nail has a hole drilled through it, and a pin is inserted through the hole.
c. The pin is embedded in a rubber mount which has a hole through the middle from top to bottom.
d. The nail moves freely along the pin within the hole in the rubber mount.
e. The separator guide is positioned between the two sides of the rubber belt where the sections cross.
f. The metal tube spins around the metal nail as the belt turns, virtually eliminating the friction.

5. A system according to claim 3 that allows the lower disk wheel to move forward and backward, thereby following the contours of the body, as follows:
a. Three support blocks form the structure of the system.
b. Two rods are fixed at the first and third block. Each rod is positioned inside a tube, which slides into a larger tube. The two larger tubes are fixed to the second block. This allows the lower shaft and the second block to move forward and backward.
c. Two springs connect the first and second block and return the disk wheel to its original position after it is pushed backward.

6. A safety spring mechanism according to claim 1, wherein the horizontal bar of the mounting apparatus is pushed securely toward the wall, as follows:
a. A hidden spring runs between the outer edge of the horizontal bar and an inner control knob.
b. The horizontal bar is mounted on top of the frame of the sliding door of the shower, with a control knob on each side of the door frame.
c. When the unit is in position, the knobs are tightened. The spring is held in a stretched position to push and hold the horizontal bar firmly against the wall.

7. A multi-function holder block according to claim 1, which serves the following five functions:
a. The multi-function holder is connected to the inner portion of the vertical support bar.
b. The multi-function holder contains two small pulleys that divide the weight of the unit among five pulleys (two in the multi-function holder and three along the horizontal bar).
c. The multi-function holder includes an H-shaped notch that maintains the pulley rope at the desired height.
d. The multi-function holder is connected to the water tank holder.
e. The multi-function holder includes a channel through which the soapy water dispensing tube is inserted; lowering the tube to a horizontal position starts the flow of water and raising the tube upright stops the flow of water.
